(19) United States
(12) Patent Application Publication
(10) Pub. No.: US 2014/0036519 A1
(43) Pub. Date: Feb. 6, 2014

(54) SPIRALING SUPPORT TUBE

(71) Applicant: Raymond L. Cloward, Magna, UT (US)

(72) Inventor: Raymond L. Cloward, Magna, UT (US)

(21) Appl. No.: 13/957,376

(22) Filed: Aug. 1, 2013

Related U.S. Application Data
(60) Provisional application No. 61/678,473, filed on Aug. 1, 2012.

(51) Int. Cl. F16M 13/00; F21V 21/14

(52) U.S. Cl. CPC F16M 13/00; F21V 21/14
USPC 362/418; 248/354.1; 248/161

(57) ABSTRACT

A support tube is formed of a length of flexible material that is shaped into a spiraling coil. The coils can be tightened by twisting to form a rigid tube. By twisting and lengthening the coils, the rigid tube can be adjusted as desired to have an appropriate diameter and length. The friction between the overlapped coils secures the tube once tightened. Different materials and modifications to the material, such as an abutment, can be made to customize the spiraling support tube for a desired function.

### CROSS-REFERENCE TO RELATED APPLICATIONS

This application claims the benefit of U.S. Provisional Patent Application No. 61/678,473 which was filed on Aug. 1, 2012.

### SUMMARY

A support tube is formed of a length of flexible material that is shaped into a spiraling coil. The coils can be tightened by twisting to form a rigid tube. By twisting and lengthening the coils, the rigid tube can be adjusted as desired to have an appropriate diameter and length. The friction between the overlapped coils secures the tube once tightened. Different materials and modifications to the material, such as an abutment, can be made to customize the spiraling support tube for a desired function.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a front perspective view of a spiraling support tube in the collapsed position;

FIG. 1B illustrates a top view of the spiraling support tube of FIG. 1;

FIG. 1C illustrates a front perspective view of the spiraling support tube of FIG. 1 in a partially extended position;

FIG. 1D illustrates a front perspective view of the spiraling support tube of FIG. 1 in a fully extended position;

FIG. 2A illustrates a securing structure that is secured around the exterior of the spiraling support tube of FIG. 1C;

FIG. 2B illustrates a securing structure that is formed within the material of the spiraling support tube of FIG. 1C;

FIG. 2C illustrates the securing structure of FIG. 2A being used in conjunction with an internal securing structure;

FIG. 3A illustrates a front perspective view of a spiraling support tube having an abutment layer;

FIG. 3B illustrates a side view of the spiraling support tube of FIG. 3A;

FIG. 3C illustrates a front perspective view of the spiraling support tube of FIG. 3A in an extended position;

FIG. 3D illustrates a detailed view of a portion of the spiraling support tube of FIG. 3C;

FIG. 3E illustrates a front perspective view of a spiraling support tube that includes notches along an edge of the material;

FIG. 4A illustrates a front perspective view of a spiraling support tube that includes a mount for supporting a camera;

FIG. 4B illustrates an exploded view of the spiraling support tube of FIG. 4A with the support tube in the collapsed position;

FIG. 4C illustrates a front perspective view of a mount that employs three spiraling support tubes to form a tripod;

FIG. 5A illustrates a spiraling support tube having a device attached at one end;

FIG. 5B illustrates a spiraling support tube having one end secured to a base while the other end secures a device;

FIG. 5C illustrates a spiraling support tube that includes an anti-slip component in one end to form a walking stick;

FIG. 6A illustrates how two spiraling support tubes can be interconnected by inserting the end of one tube into the end of another tube;

FIG. 6B illustrates a securing device that can be used to secure two spiraling support tubes together;

FIG. 7 illustrates a spiraling support tube that is configured to allow an end of the tube to attach to an object to support the tube; and

FIG. 8 illustrates a multi-tube support tube that can be created from a single length of material.

### DETAILED DESCRIPTION

The present invention extends to a spiraling support tube and to various applications of a spiraling support tube. A spiraling support tube can be formed of a length of thin flexible material such as plastic. Other thin flexible material could also be used including metals. In some embodiments, a stretched polyester film such as biaxially-oriented polyethylene terephthalate (BoPET) can be used. The thickness of the material can be selected based on a desired strength of the support tube. For example, plastic of 3, 4, or 10 mils could be selected. Of course, any other thickness could also be selected. The thickness of the material could also vary (e.g. along the length or width).

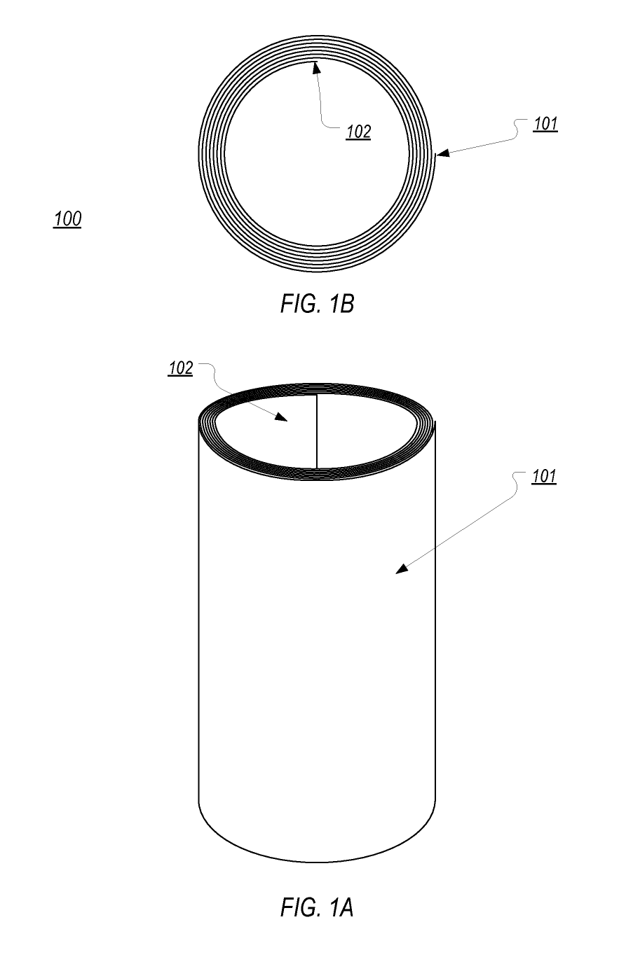

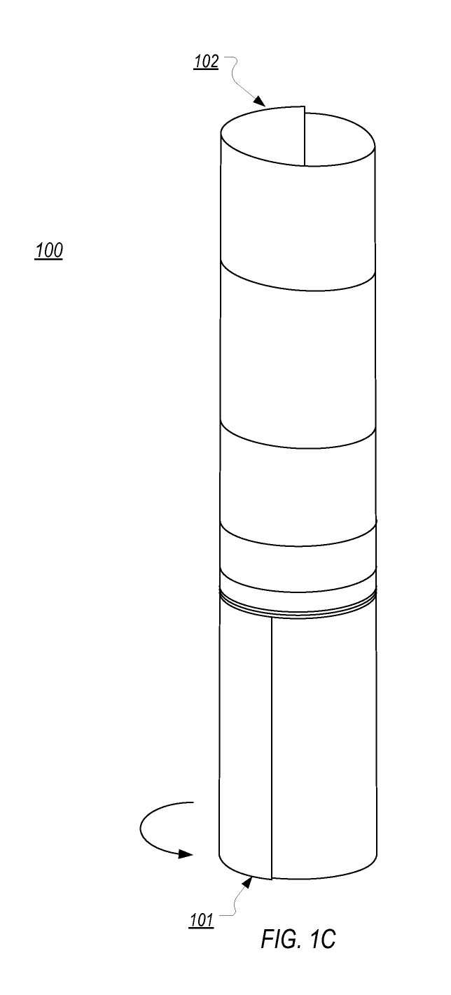

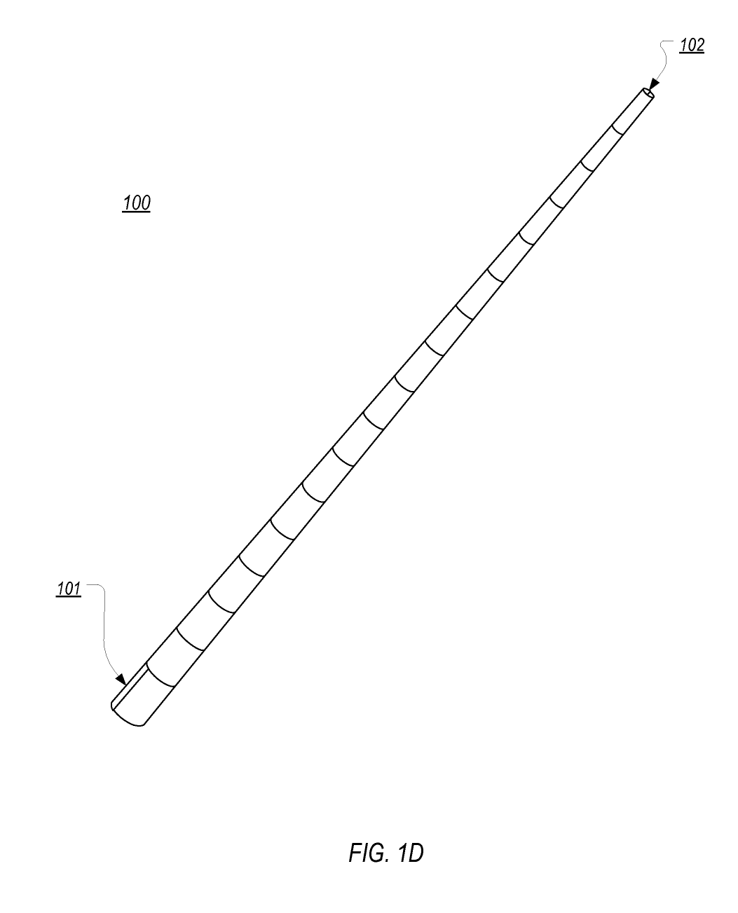

FIG. 1A illustrates a front perspective view and FIG. 1B illustrates a top view of a spiraling support tube 100 in the collapsed orientation. In some embodiments, the material can be thermoset or manufactured set to maintain its coil shape in the absence of external forces.

The coil shape can be set as a cylinder as shown in FIGS. 1A and 1B or can be set to naturally extend into a cone (e.g. as shown in FIG. 1C). As stated above, the default shape of a tube can be set using a heat setting technique. A tube set to have a cylindrical default shape can provide greater strength at the outer wrap end because of the increased number of coils that can be positioned near the outer wrap end when the tube is tightened.

If set into a cone shape, the cone can be set to any length. Regardless of how the coil shape is set, the spiraling support tube can be extended into a solid support tube by twisting the material together in the appropriate direction.

For example, as shown in FIGS. 1C and 1D, the spiraling support tube 100 can be extended by pulling the internal (or alternatively the external) coils outwardly. Then, the rigidity of the tube can be set by twisting the coils together. As shown in FIG. 1C, support tube 100 is tightened by twisting the coils in the clockwise direction (when viewed from the bottom of support tube 100) as indicated by the arrow. In other words, support tube 100 is tightened by twisting the coils in the direction of their coiling.

When twisted, each coil tightens around the coil directly within it. This tightening creates a frictional force that prevents the coils from sliding with respect to one another. In other words, the overlapped portions of the coils bind together due to the frictional force to prevent shortening or lengthening of the tube without first loosening the coiling. Accordingly, the coiled length of material can be formed into a spiraling support tube of many different lengths and diameters.

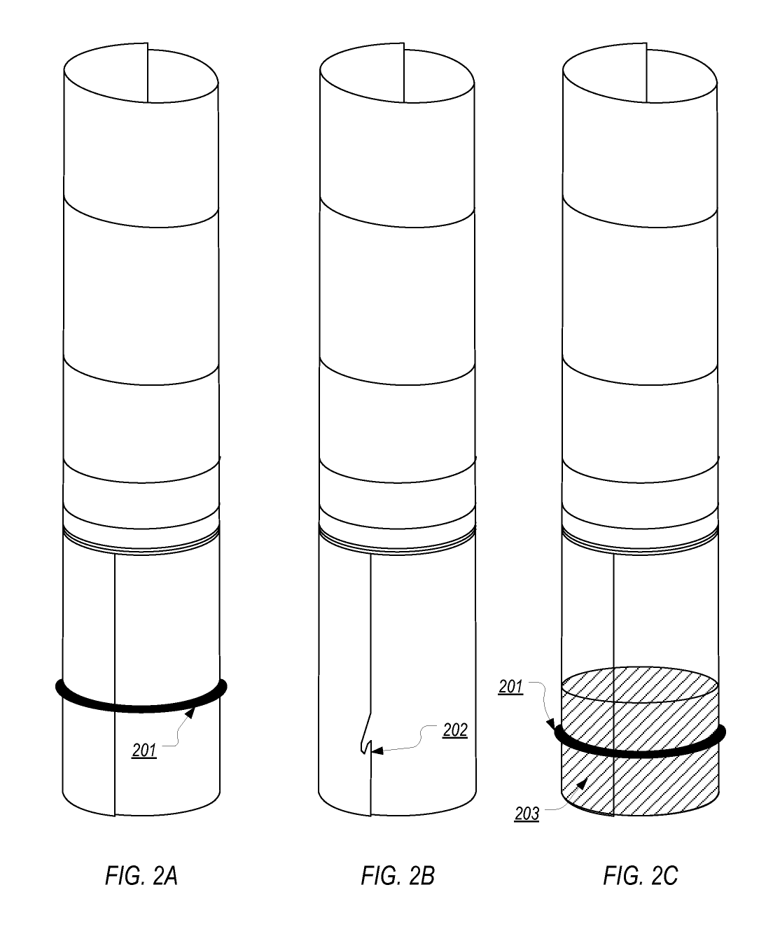

To maintain a tube in the extended tightened position, a securing structure or retention means can be attached to the tube to prevent the coils from loosening (i.e. to prevent the diameter of the coils from expanding). Any type of securing structure can be used to prevent the structure from loosening. Two general types of securing structures can be used as shown in FIGS. 2A and 2B.

FIG. 2A illustrates a securing structure 201 that extends around the tube. In some embodiments, securing structure 201 can be elastic or spring loaded to cause an inward force to be applied to the tube. In some embodiments as shown in FIG. 2C, an inner support structure 203 can be used in conjunction with securing structure 201 Inner support structure 203 can provide reinforcement to the tube to enable securing structure 201 to apply substantial force for securing the tube.

FIG. 2B illustrates a securing structure 202 that is formed within the material of the tube. Securing structure 202 can be formed as a hook that inserts into a corresponding hook or hole in the material.

In some embodiments, no securing structure may be required. For example, the frictional force between coils can be sufficient in some applications to maintain the shape of the tube without requiring a separate securing structure.

In some embodiments, a securing structure can also serve as a container for the tube. For example, a cylindrical container having a height that is the same as or near the height of the tube when compacted can be used to contain the tube. In such cases, the container can also apply a securing force around the tube when in the extended position. In other words, the coils of the tube can be extended out from the container. Then, the tube can be twisted to cause the coils to tighten within the container or the container can be configured to apply an inward force to implement the securing structure around the tube.

Because the coils overlap, the effective thickness of the spiraling support tube is increased thereby increasing the longitudinal strength of the spiraling support tube. This overlap ensures that there is increased thickness along the entire length of the material. Therefore, the spiraling support tube can be stronger than a telescoping tube made of the same material and thickness. This is because a telescoping tube does not include overlapping coils, and therefore includes lengths where the tube has a thickness equal only to the thickness of the material.

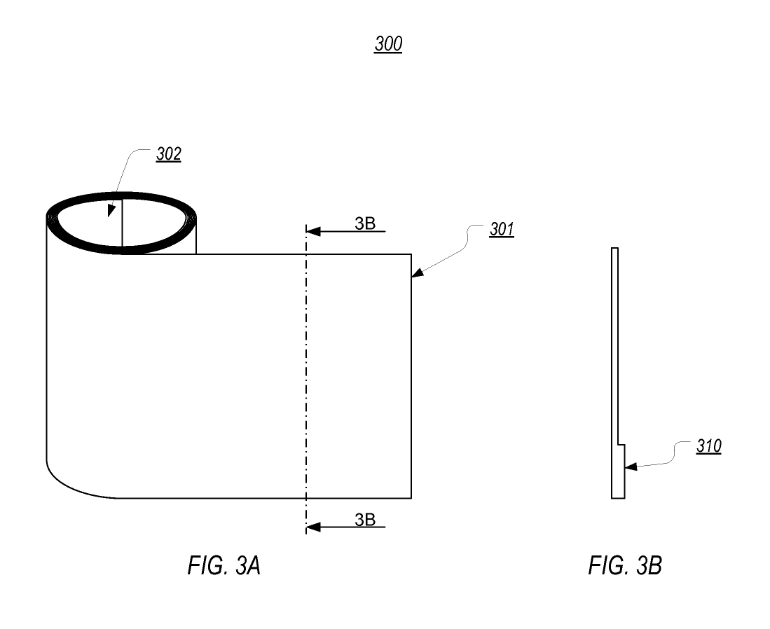

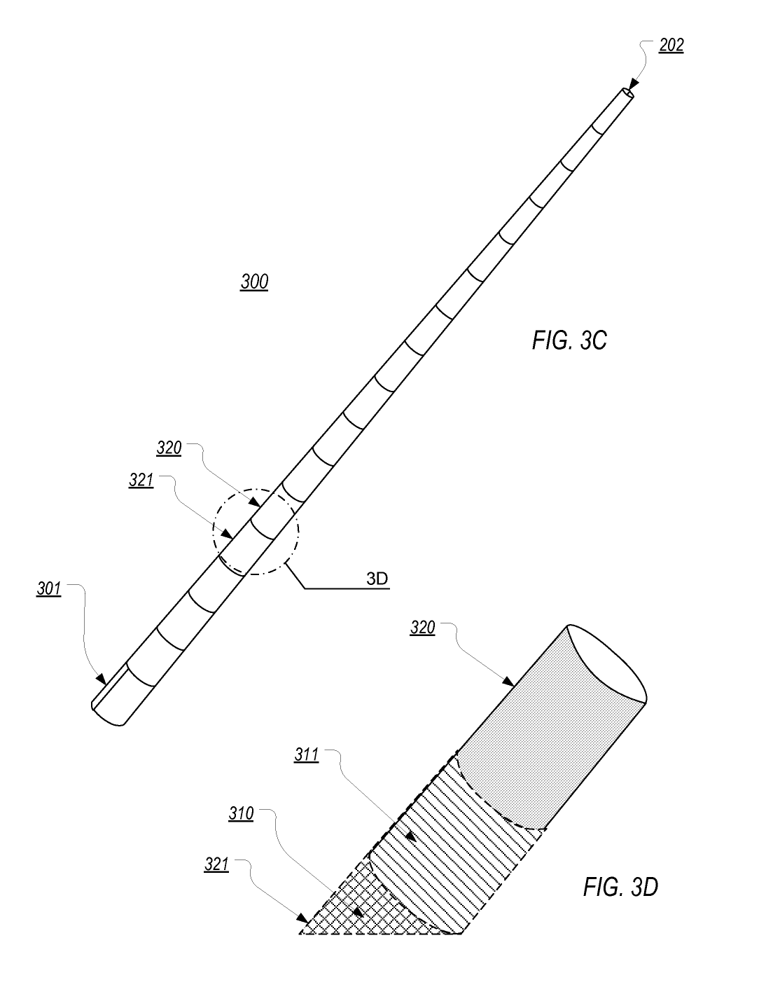

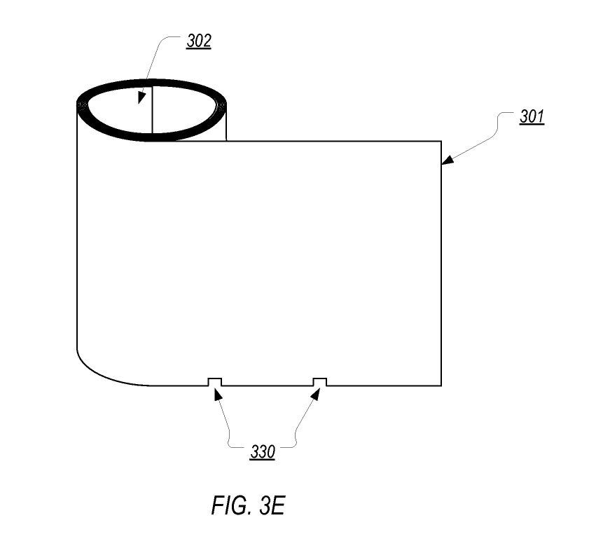

To further increase the strength of the support tube, an abutment layer 310 can be formed in the material as shown in FIGS. 3A-3C. Abutment layer 310 can be formed by folding a side of the material, can be formed in the material (e.g. as a pre-formed or added ridge or projection in the material) such as is shown in FIG. 3B, or added to the material (e.g. as a ridge attached to the material). An abutment layer can be continuous along an edge of the material or can be comprised of a number of spaced portions of expanded width.

FIG. 3B illustrates a cross-sectional side view of the spiraling support tube 300 shown in FIG. 3A. As shown, abutment layer 310 is formed as a portion of the material having a greater thickness than the remaining portions of the material. An abutment layer provides additional strength when the edge of a coil contacts the abutment layer of the adjacent coil. When the coil abuts the abutment layer, the coil's longitudinal movement is limited.

For example, FIG. 3C illustrates a coil 320 and an adjacent coil 321. FIG. 3D provides a detailed view of these coils to illustrate that the bottom portion 311 of coil 320 contacts the abutment layer 310 of the adjacent coil 321. In this position, coil 320 cannot further move longitudinally towards adjacent coil 321.

An abutment layer can be formed on the inside of the material (as shown in FIGS. 3A-3C) or the outside of the material. In each case, the abutment layer can serve to increase the strength of the material. For example, the increased thickness of the abutment layer can increase the frictional force between adjacent coils thereby increasing the layer upon layer binding that occurs.

In other embodiments as shown in FIG. 3E, notches 330 can be formed along the edge of the material. Notches 330 can provide means for locking into an adjacent coil. In other words, when the edge of one coil inserts into a notch of another coil, the edge can be prevented from further longitudinal movement towards the adjacent coil.

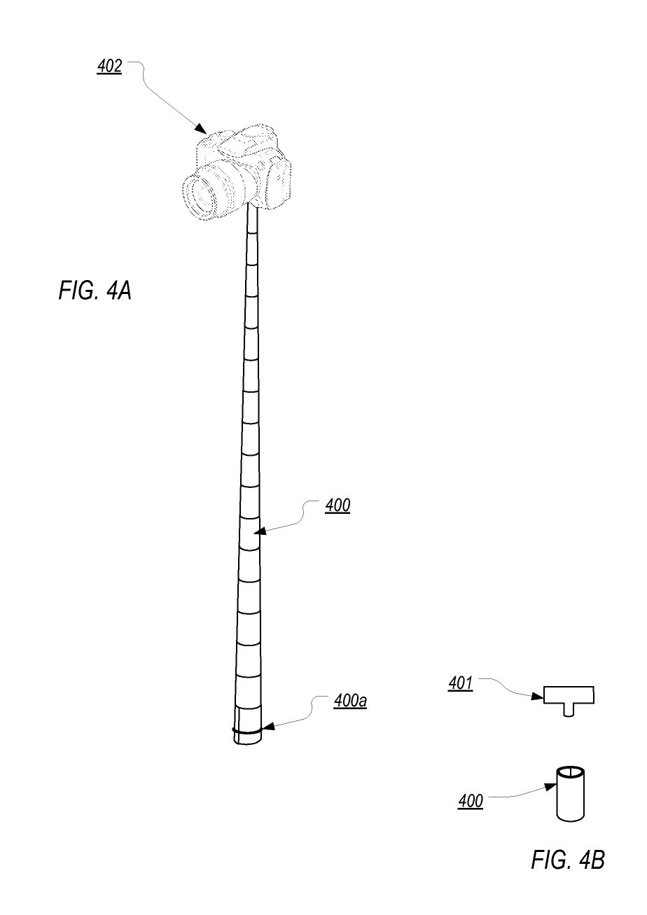

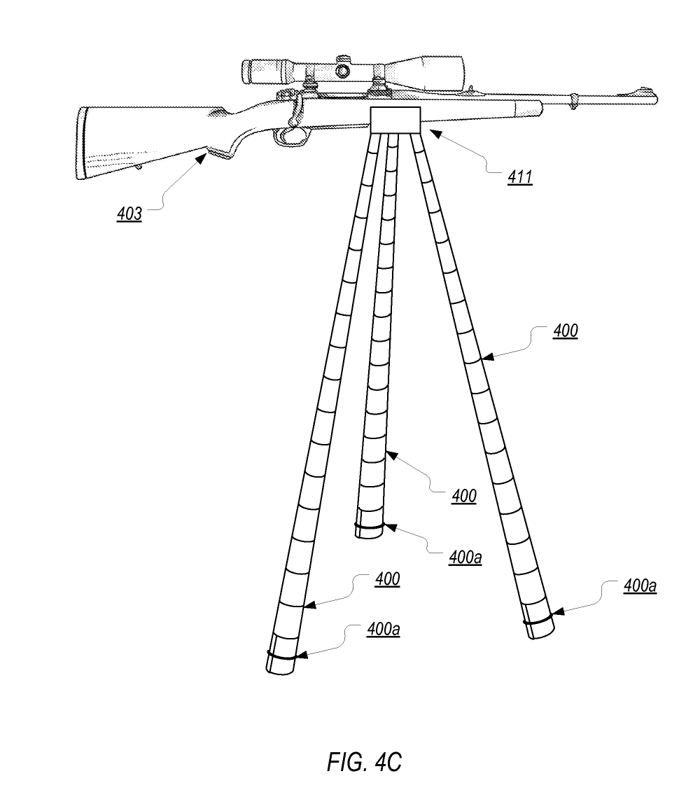

The spiraling support tube of the present invention can be used for many different applications including both heavy and light duty applications. FIGS. 4-8 illustrate various exemplary applications for the spiraling support tube. In these figures, a securing mechanism 400a that is similar to securing mechanism 201 is shown. However, any other type of securing mechanism (including securing mechanisms similar to securing mechanism 202 or container-like securing mechanisms) can be used. In some embodiments, a securing mechanism may not be used such as when the intrinsic friction between the coils provides sufficient resistance to retain the desired shape of the tube.

FIG. 4A illustrates a spiraling support tube 400 that is being used as a support for a camera 402. In such embodiments, a mount 401, shown in FIG. 4B, can be configured to insert into or overtop of the top end of spiraling support tube 400. Once support tube 400 is tightened (and possibly secured with a securing mechanism 400a), support tube 400 can retain sufficient strength to support camera 402. As shown in FIG. 4B, spiraling support tube 400 can be collapsed to have a height that is equal to the width of the material. In this way, a support tube can be formed that requires minimal space to store and carry. In other embodiments, a mount can be configured to secure the outer coil end of the support tube (e.g. by having the inner coil end on the ground) and therefore the mount can serve as a securing structure.

FIG. 4C illustrates another example embodiment that employs three support tubes 400 in conjunction with a mount 411 for supporting a rifle 403. Mount 411 can be configured to retain each of support tubes 400 to form a tripod. Because support tube 400 can be adjusted in length, the supports illustrated in FIGS. 4A-4C can be set to many different heights. Securing mechanisms 400a can be used to retain tubes 400 in the extended position. Alternatively, mount 411 can be configured as the securing mechanism such that the outer coil end of the tubes inserts into mount 411. One or more spiraling support tubes 400 can be used to support many other types of devices or objects in addition to the camera and rifle shown in FIGS. 4A-4C.

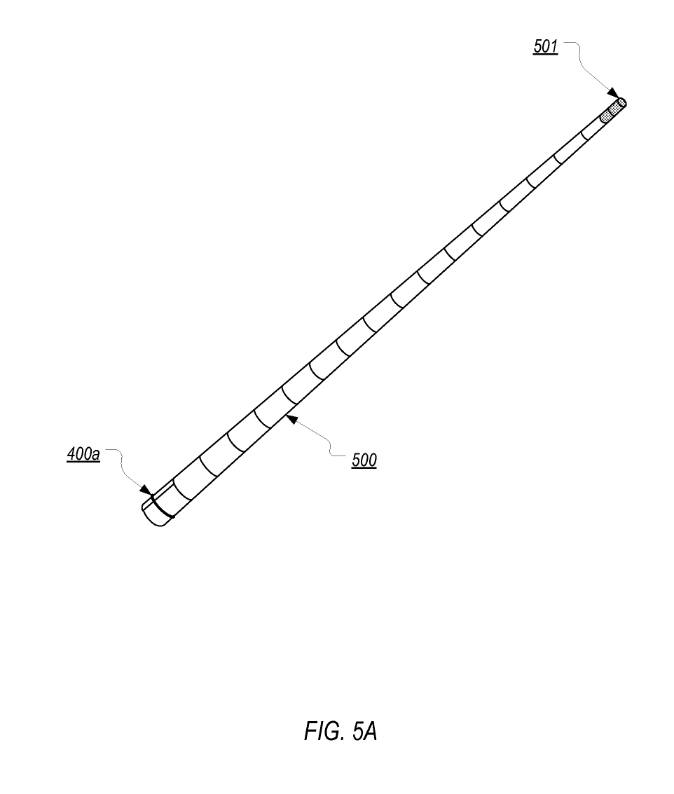

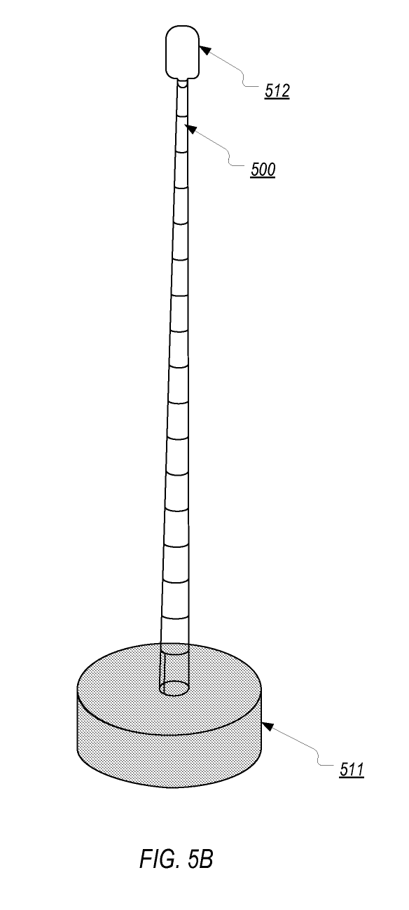

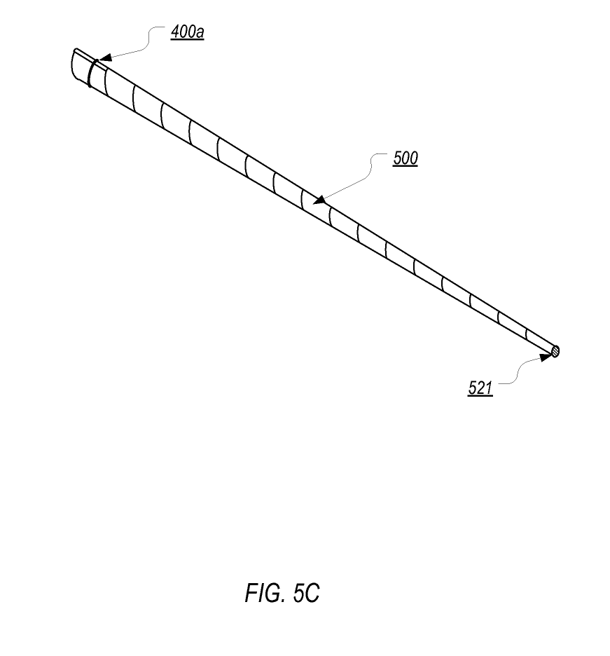

FIG. 5A illustrates an example embodiment where a device 501 is inserted into or attached to an end of a spiraling support tube 500. Although device 501 is attached to the inner coil end in FIG. 5A, a device can be alternatively or additionally attached to the outer coil end as well. In some embodiments, device 501 can be a flashlight thereby converting support tube 500 into a lengthened flashlight. In such embodiments, device 501 can be permanently attached to support tube 500 or can be inserted into support tube 500 when desired for use. In some embodiments, the device can also serve as the securing mechanism while in others, a separate securing mechanism (e.g. securing mechanism 400a) can be used to retain the tube 500 in the extended position.

FIG. 5B illustrates an example embodiment where the bottom of spiraling support tube 500 is inserted into or otherwise secured by a base 511 while the top of support tube 500 includes a light 512. In such embodiments, spiraling support tube 500 can form an adjustable height lamp or light. For example, base 511 can include a battery or other source of electricity for powering light 512. Because support tube 500 can be collapsed into a height that equals the width of its material, the adjustable height lamp or light has a compact design.

In FIG. 5B, base 511 forms the securing mechanism for tube 500. However, in some embodiments, a separate securing mechanism can be used. Also, in some embodiments, tube 500 can be inverted so that the bottom of the tube (i.e. the outer wrap end of the tube) is facing upward. In such embodiments, a separate securing mechanism can be used to secure the outer wrap end in a shape that can contain a light or other device, while the inner wrap end can be inserted into or otherwise connected to base 511.

FIG. 5C illustrates an example embodiment where spiraling support tube 500 can be used as a walking stick. In such embodiments, support tube 500 can include an anti-slip component 521. A securing mechanism 400a can also be used to maintain the walking stick in the extended position. A walking stick configured in this manner can be useful due to its ability to be compacted to a minimal size while still retaining sufficient rigidity to provide support while walking In some embodiments, support tube 500 can also be used as a guide stick for the blind. In some embodiments, a light may be included within the walking or guide stick.

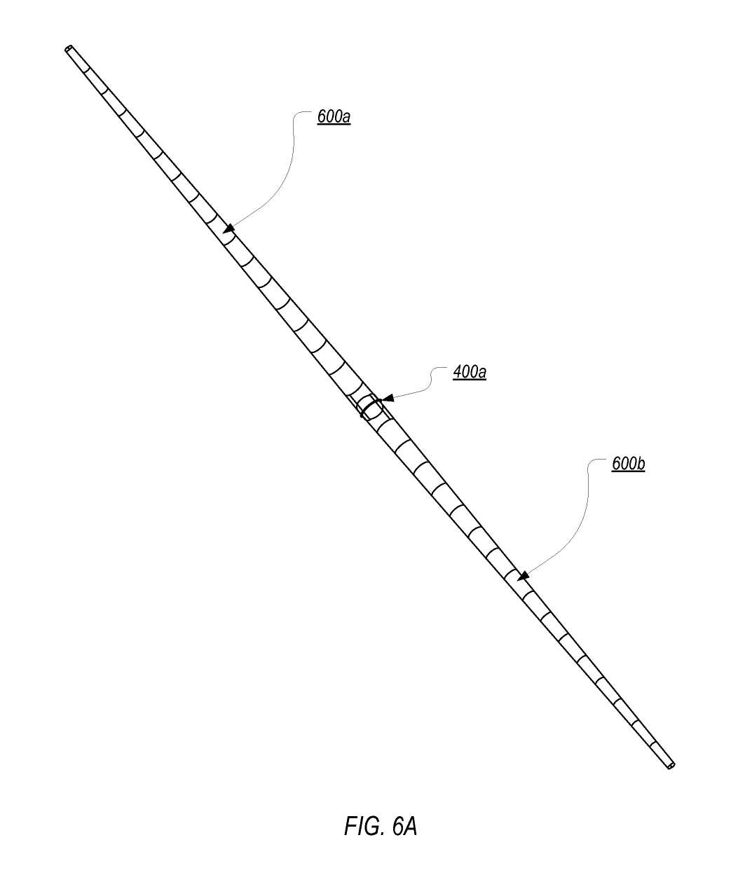

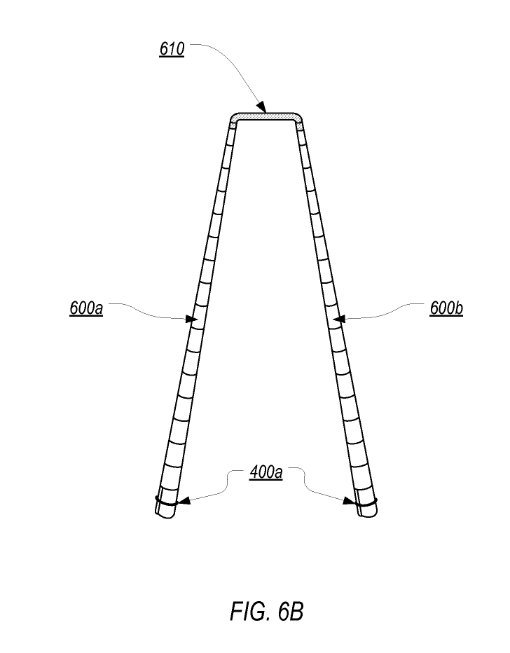

In some embodiments, multiple support tubes can be configured to interconnect. For example, FIG. 6A illustrates an embodiment where two support tubes 600a, 600b are interconnected by inserting the end of one tube into the end of another tube. The outer tube can be tightened around the inner tube to secure the two tubes together using the frictional force created by the material. In such cases, the outer tube can serve as the securing mechanism for the inner tube so that only a single securing mechanism around the outer tube is required.

FIG. 6B illustrates an embodiment where support tubes 600a, 600b are interconnected via a connector 610. In some embodiments, connector 610 can be relatively rigid to allow the relative positions of tubes 600a, 600b to be retained. A connector for connecting more than two tubes together can also be used.

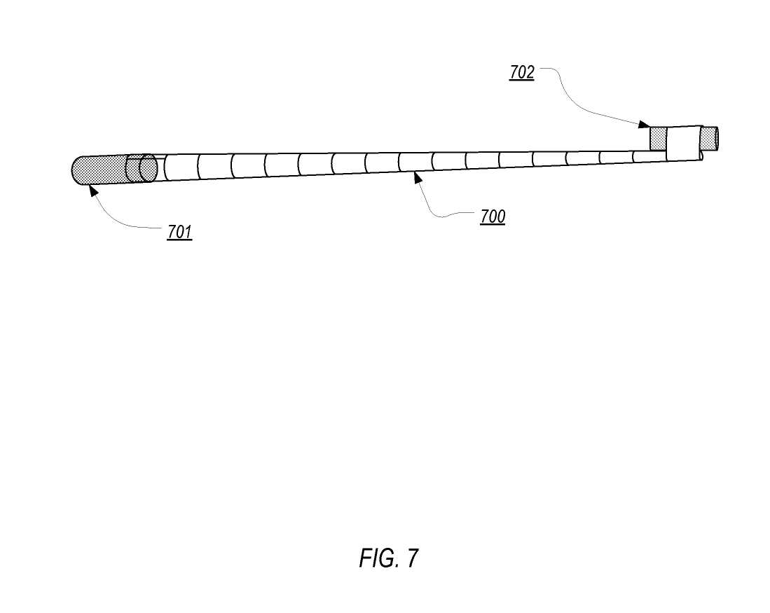

FIG. 7 illustrates an embodiment where a support tube 700 is configured to be secured to or hung from an object 702. As shown, support tube 700 includes a flashlight 701 although another object could be contained within the end of support tube 700. The end of support tube 700 opposite flashlight 701 is unraveled sufficiently to wrap the end around object 702. Support tube 700 can therefore be hung from or secured to object 702.

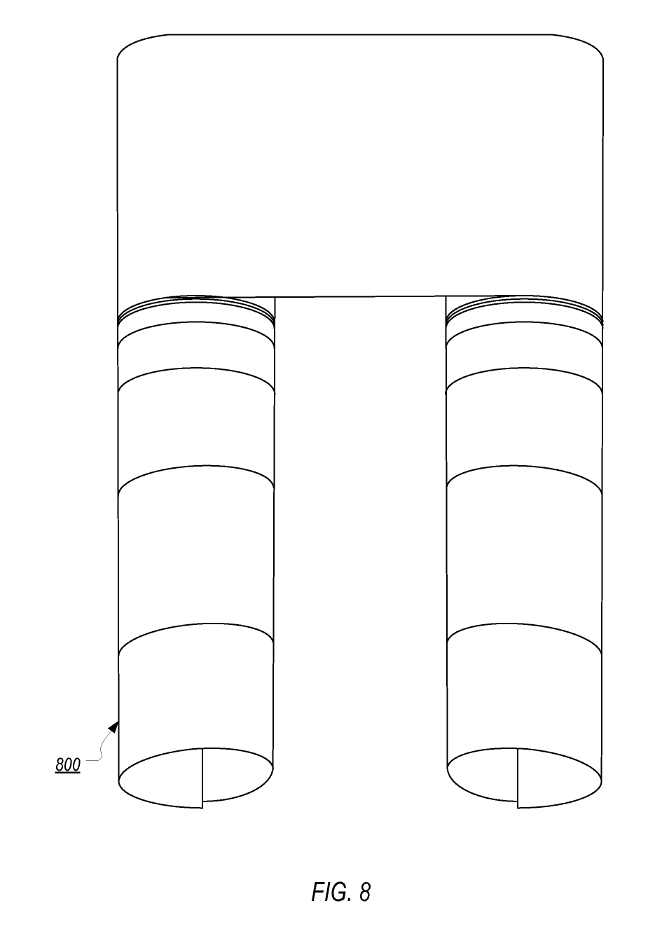

FIG. 8 illustrates an embodiment of a multi-tube support tube 800. A single length of material can be used to form a multi-tube support tube by wrapping the material into two separate columns. In the embodiment shown in FIG. 8, each column has coils wrapped in the opposite direction and therefore each tube is tightened by twisting in opposite directions. In other embodiments, a multi-tube support tube can be formed so that each column has coils wrapped in the same direction and therefore each tube can be tightened by twisting in the same direction.

In some embodiments, a support tube can include internal wiring. The wiring can be laminated within the material or otherwise attached to the material. In such embodiments, the spiraling support tube can be used as an extension for an electrical apparatus. For example, a light bulb could be connected to one end of the support tube to form an extendible flashlight or lamp. Various wires that are laminated, attached or otherwise contained within the material, as well as circuitry, sensors, LEDs, etc. could be included in the material. Such components could be used for different purposes such as for supplying power or for carrying data (e.g. as an antenna or antenna extension, an extension for a microphone, etc.).

In some embodiments, a spiraling support tube can be used as a handle for a tool. For example, a spiraling support tube can be attached to a typical hand tool thus providing a convenient extension to the handle of the hand tool. The diameter of the spiraling support tube can be adjusted to secure the handle or the object as desired. Once the tube has been secured around the handle or object, the length of the tube can be expanded to provide the desired handle length.

The spiraling support tube of the present invention can also be used as an extendible conduit. For example, the support tube can form an extendible hose or pipe for carrying water or other fluid. The spiraling support tube can be used as a conduit for many other applications including as a stent for medical uses, as a electrical conduit, etc.

The spiraling support tube can also be used without any attaching device, for example, as a rescue pole or a javelin. In some embodiments, a spiraling support tube set in an extended configuration is more desirable. When set in an extended configuration, the tube, when compressed, will spring back to the extended position. Accordingly, the tube can be compressed for storage in a minimal area, but quickly extended when needed. Examples of such uses include a spring out rescue pole, or a spiraling conduit.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A spiraling support tube comprising:
a coiled length of material having a width, wherein the coils are extendible to elongate the coiled length of material into a tube, and wherein the coils are tightened by twisting the coils to form a rigid tube, the coiled length of material being compressible such that the minimum height of the tube is equal to the width of the material, and wherein a first portion of the width of the material comprises an abutment layer having a greater thickness then another portion of the width of the material.

2. The spiraling support tube of claim 1, wherein the abutment layer comprises a portion along an edge of the material.

3. The spiraling support tube of claim 2, wherein the abutment layer is formed by one of:
folding the edge of the material; or
manufacturing the material with a greater thickness in the first portion.

4. The spiraling support tube of claim 1, further comprising:
a device attached to the end of the tube.

5. The spiraling support tube of claim 4, wherein the device is inserted into the end of the tube and secured within the tube via frictional force between the tube and the device.

6. The spiraling support tube of claim 4, wherein the device is a light.

7. The spiraling support tube of claim 1, wherein the material includes embedded wires or circuitry for carrying electrical signals or power.

8. The spiraling support tube of claim 1, further comprising a securing structure.

9. The spiraling support tube of claim 8, wherein the securing structure is attached to the exterior of the tube to hold the tube in an extended position.

10. The spiraling support tube of claim 8, wherein the securing structure is configured as a container for the tube when the tube is in a collapsed position.

11. The spiraling support tube of claim 8, wherein the securing structure is formed within the material.

12. The spiraling support tube of claim 1, wherein the material is one of plastic or metal.

13. The spiraling support tube of claim 1, wherein the material is polyester based having a thickness between 3 and 10 mils.

14. The spiraling support tube of claim 1, wherein the material is heat set to maintain a desired form.

15. The spiraling support tube of claim 1, wherein the coils are set to have a conical shape.

16. The spiraling support tube of claim 1, wherein one end of the tube is secured in a base to form an extendable stand.

17. A spiraling support tube comprising:
a coiled length of material, wherein the coils are extendible to elongate the coiled length of material into a tube, and wherein the coils are tightened by twisting the coils to form a rigid tube, the coiled length of material being compressible such that the minimum height of the tube is equal to the width of the material; and
a mount that is connectable to an end of the tube, the mount configured to support an object when the mount is connected to the top of the tube when the tube is in a vertical position.

18. The spiraling support tube of claim 17, wherein the mount comprises a securing structure for securing the tube in an extended position.

19. A spiraling support tube comprising:
a coiled length of material, wherein the coils are extendible to elongate the coiled length of material into a tube, and wherein the coils are tightened by twisting the coils to form a rigid tube, the coiled length of material being compressible such that the minimum height of the tube is equal to the width of the material; and
a light that is secured within an end of the tube.

20. The spiraling support tube of claim 19, wherein the other end of the tube is configured to wrap around an object to secure the tube to the object.
